(19) United States
(12) Patent Application Publication
(10) Pub. No.: US 2025/0171236 A1
(43) Pub. Date: May 29, 2025

(54) Control System, Conveyance System, and Control Method

(71) Applicant: Hitachi Industrial Products, Ltd., Chiyoda-ku, Tokyo (JP)

(72) Inventors: Hisashi ENDO, Tokyo (JP); Koichi NAKANO, Tokyo (JP)

(21) Appl. No.: 18/838,700

(22) PCT Filed: Mar. 25, 2022
(86) PCT No.: PCT/JP2022/014326

§ 371 Date: Aug. 15, 2024

(51) Int. Cl. B65G 1/137; B65G 1/10

(52) U.S. Cl. CPC B65G 1/1373; B65G 1/10

(57) ABSTRACT

A control system includes: a storage device that stores storage information including information regarding an article stored in a movable shelf for storing articles and a storage position of the article; and an arithmetic device that controls traveling of a conveyance device that loads and conveys the movable shelf, wherein the arithmetic device calculates a characteristic regarding a weight distribution of the movable shelf on the basis of the storage information, and determines a traveling condition including information on at least one of speed and acceleration of the conveyance device on the basis of the characteristic regarding the weight distribution.

### TECHNICAL FIELD

The present invention relates to a shelf conveyance type conveyance device and a conveyance control system using the same.

### BACKGROUND ART

In the distribution center, an event of extracting a product from a warehouse occurs according to an article order via a network. One of conveyance devices used to extract articles is a shelf conveyance type automated guided vehicle. On the basis of the article extraction event, the automated guided vehicle conveys a shelf accommodating the article. The shelf moves to a picking station which is a work place where a worker who extracts the article waits, and the ordered article is extracted.

Information on the name, quantity, and accommodation position of the product accommodated in the shelf may be managed by a warehouse control device (WCS: Warehouse Control System). In this case, the size and weight of the article to be accommodated in the shelf are set in advance, and an increase or decrease in the quantity is managed at the time of an event of extracting the product or replenishing the product.

In a conveyance system using the conveyance device as described above, traveling may be performed according to a loading situation such as the weight and posture of the conveyance object to be conveyed by the conveyance device.

As the background art of the present technical field, for example, PTL 1 (JP 2001-31391 A) describes a maximum vehicle speed control device for a forklift including: a vehicle speed detecting means for detecting a vehicle speed; a first maximum vehicle speed setting means for setting a first maximum vehicle speed; a load-handling state detecting means for detecting a load-handling state; a first maximum vehicle speed determining means for determining a second maximum vehicle speed from the load-handling state detected by the load-handling state detecting means; a second maximum vehicle speed determining means for comparing the first maximum vehicle speed with the second maximum vehicle speed and determining, as a third maximum vehicle speed, the lower maximum vehicle speed, or in the case of identical maximum vehicle speeds, the maximum vehicle speed; and a vehicle speed control means for controlling the vehicle speed on the basis of the vehicle speed detected by the vehicle speed detecting means and the third maximum vehicle speed determined by the second maximum vehicle speed determining means.

### CITATION LIST

### Patent Literature

PTL 1: JP 2001-31391 A

### SUMMARY OF INVENTION

### Technical Problem

In the conveyance system using the shelf conveyance type conveyance device in a warehouse, a factory, or the like, when an article is stored in a shelf to be loaded, weight characteristics of the shelf change on the basis of a storage position of the article. Then, the inventor has found that, the shaking occurring in the shelf to be loaded or the conveyance device when the conveyance device travels differs according to the weight characteristics based on the storage position of the article in addition to the weight and posture of the conveyance object described above. When the conveyance device travels under the same traveling condition, vibration regarding the article stored on the shelf, a possibility of falling off from the shelf, and a physical load on the conveyance device differ depending on weight characteristics of the shelf to be loaded. Therefore, in order to improve the storage quality of the article and improve the reliability of the conveyance system, it is desirable to perform travel control according to the weight characteristics of the shelf to be loaded. As a result, it is desirable that the conveyance device can perform conveyance as efficiently as possible without affecting the storage quality of the article and the reliability of the conveyance system.

In the technique described in PTL 1, it is not considered to control the traveling speed and acceleration/deceleration of the conveyance device in consideration of the weight characteristics of the object to be loaded.

The present invention has been made in view of the above, and an object thereof is to provide a control system capable of performing travel control according to weight characteristics of a shelf to be loaded. As a result, it is possible to contribute to improvement in storage efficiency of articles and improvement in reliability of the conveyance system.

### Solution to Problem

A typical example of the invention disclosed in this application is as follows. That is, a control system includes: a storage device that stores storage information including information regarding an article stored in a movable shelf for storing articles and a storage position of the article; and an arithmetic device that controls traveling of a conveyance device that loads and conveys the movable shelf, wherein the arithmetic device calculates a characteristic regarding a weight distribution of the movable shelf on the basis of the storage information, and determines a traveling condition including information on at least one of speed and acceleration of the conveyance device on the basis of the characteristic regarding the weight distribution.

### Advantageous Effects of Invention

According to one aspect of the present invention, it is possible to perform travel control according to the weight characteristics of the shelf to be loaded, and it is possible to contribute to improvement in storage efficiency of articles and improvement in reliability of the conveyance system. Problems, configurations, and effects other than those described above will become apparent from the description of the following embodiments.

### BRIEF DESCRIPTION OF DRAWINGS

FIG. 1 is a diagram illustrating a configuration of a conveyance control system according to an embodiment of the present invention.

FIG. 2 is a diagram illustrating the configuration of the conveyance control system according to the present embodiment.

FIG. 3 is a diagram illustrating a configuration example of inventory information according to the present embodiment.

FIG. 4 is a perspective view illustrating an example of a layout of a warehouse in a distribution center.

FIG. 5 is a perspective view illustrating a configuration example of a conveyance device and a shelf.

FIG. 6 is a flowchart of an article unloading process according to the present embodiment.

FIG. 7 is a flowchart of an article loading process according to the present embodiment.

FIG. 8 is a flowchart of a speed/acceleration determination process according to the present embodiment.

FIG. 9 is a diagram illustrating an article weight center of the shelf according to the present embodiment.

FIG. 10 is a diagram illustrating the article weight center of the shelf according to the present embodiment.

FIG. 11 is a diagram illustrating a configuration example of a travel parameter determination table in straight movement according to the present embodiment.

FIG. 12 is a diagram illustrating a configuration example of a rotation parameter determination table in rotational movement according to the present embodiment.

### DESCRIPTION OF EMBODIMENTS

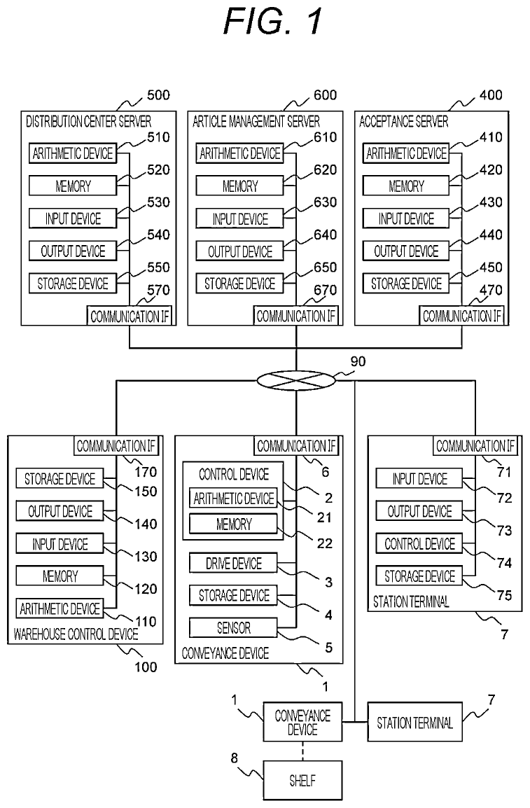

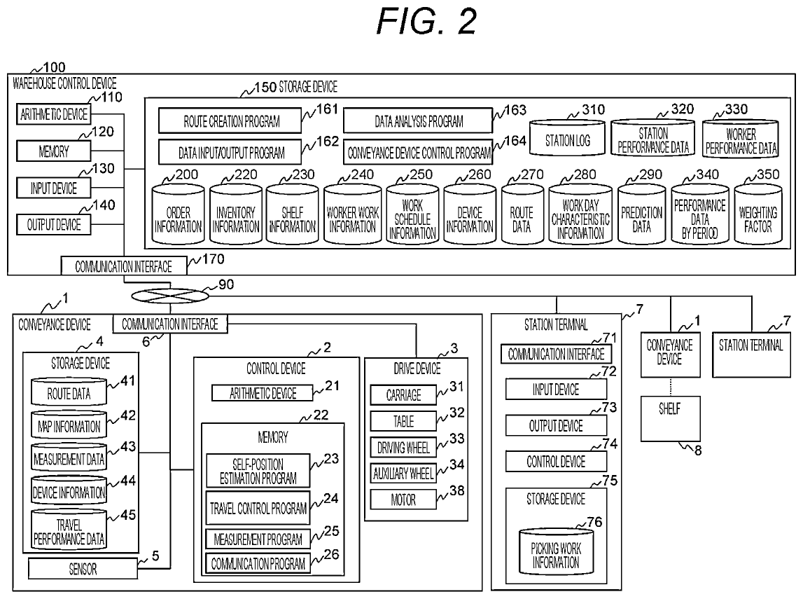

FIGS. 1 and 2 are diagrams illustrating a configuration of a conveyance control system according to an embodiment of the present invention. FIG. 1 illustrates an overall configuration of the conveyance control system, and FIG. 2 illustrates detailed configurations of a warehouse control device 100, a conveyance device 1, and a station terminal 7.

The conveyance control system of the present embodiment includes the warehouse control device 100, an article management server 600, an acceptance server 400, a distribution center server 500, a plurality of conveyance devices 1, and a plurality of station terminals 7. The warehouse control device 100, the acceptance server 400, the distribution center server 500, the article management server 600, the conveyance device 1, and the station terminal 7 are connected via a network 90.

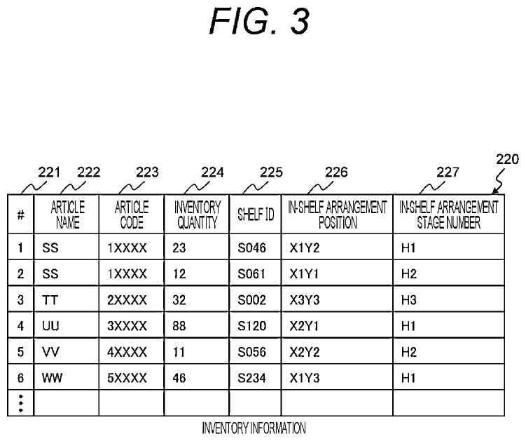

In the present embodiment, an example is illustrated in which a worker operates the station terminal 7 set in the warehouse of the distribution center, so that the warehouse control device 100 conveys the shelf 8 (storage unit) to the conveyance device 1 to a picking station 16 (or a work station), and the worker 17 performs a picking work (see FIG. 3). Here, the shelf is not limited to the illustrated example, and may be a storage portion having a plurality of compartments and capable of storing one or more articles in each compartment.

The acceptance server 400 is a front-end computer system (For example, a web server) that accepts an order of an article from a user, and includes an arithmetic device 410 that executes a program, a memory 420 accessible by the arithmetic device 410, an input device 430 to which data is input, an output device 440 that outputs an execution result of the program, a storage device 450 that stores, in a nonvolatile storage medium, the program executed by the arithmetic device 410 and data used when the program is executed, and a communication interface 470 that controls communication with other devices via the network 90.

The distribution center server 500 is a computer system that integrally manages data in the distribution center, and includes an arithmetic device 510 that executes a program, a memory 520 accessible by the arithmetic device 510, an input device 530 to which data is input, an output device 540 that outputs an execution result of the program, a storage device 550 that stores, in a nonvolatile storage medium, the program executed by the arithmetic device 510 and data used when the program is executed, and a communication interface 570 that controls communication with other devices via the network 90.

The article management server 600 is a computer system that manages loading and unloading of articles in a warehouse, and includes an arithmetic device 610 that executes a program, a memory 620 accessible by the arithmetic device 610, an input device 630 to which data is input, an output device 640 that outputs an execution result of the program, a storage device 650 that stores, in a nonvolatile storage medium, the program executed by the arithmetic device 610 and data used when the program is executed, and a communication interface 670 that controls communication with other devices via a network 90.

The programs executed by arithmetic devices 110, 410, 510, and 610 of the warehouse control device 100, the acceptance server 400, the distribution center server 500, and the article management server 600 are provided to the computers 100, 400, 500, and 600 via a removable medium (such as a CD-ROM and a flash memory) or the network 90, and stored in the nonvolatile storage devices 150, 450, 550, and 650 which are non-transitory storage media. For this reason, each of the computers 100, 400, 500, and 600 may have an interface for reading data from a removable medium.

The warehouse control device 100 is a computer system that controls the movement of the conveyance device 1 in the warehouse, and is a computer including the arithmetic device 110 that executes a program, a memory 120 that can be accessed by the arithmetic device 110, an input device 130 that is constituted by a keyboard, a mouse, a touch panel, or the like and to which data is input, an output device 140 that is constituted by a display or the like and that outputs an execution result of the program, a storage device 150 that stores, in a nonvolatile storage medium, the program executed by the arithmetic device 110 and data used when the program is executed, and a communication interface 170 that controls communication with other devices via the network 90.

The storage device 150 stores a route creation program 161, a data input/output program 162, a data analysis program 163 (control unit), and a conveyance device control program 164. The arithmetic device 110 reads a necessary program from the storage device 150, loads the program into the memory 120, and executes the program. In addition, the storage device 150 stores order information 200, inventory information 220, shelf information 230, worker work information 240, work schedule information 250, device information 260, route data 270, work day characteristic information 280, prediction data 290, station log 310, station performance data 320, worker performance data 330, performance data by period 340, and a weighting factor 350.

The route creation program 161 refers to map information (not illustrated) set in advance as a route on which the conveyance device 1 moves, calculates a route on which the conveyance device 1 moves, for example, from a position of an article to be picked and a position of the picking station 16 as a conveyance destination, and stores the calculated route in the route data 270.

The conveyance device control program 164 commands the available conveyance device 1 for the shelf 8 to be conveyed and the picking station 16 as a conveyance destination on the basis of the route calculated by the route creation program 161, the device information 260, and the like. The command to the conveyance device 1 includes: information necessary for the operation of the conveyance device 1, such as a traveling speed, a traveling acceleration, and a rotation angle.

The data input/output program 162 receives order information, an input from the station terminal 7 operated by the worker 17, and sensor data from the conveyance device 1, and accumulates the data in the station log 310. In addition, when receiving a departure command of the conveyance device 1 from the station terminal 7, the data input/output program 162 transmits the command generated by the conveyance device control program 164 to the conveyance device 1.

The data analysis program 163 generates, on the basis of the station log 310, the station performance data 320 in which the work time is recorded for each picking station 16 and the worker performance data 330 in which the work time is recorded for each worker, aggregates the performance data by period 340 as described later, calculates work prediction data for each picking station, and stores the work prediction data in the prediction data 290.

The data analysis program 163 aggregates the content of the prediction data 290 to generate a prediction screen 51, displays the prediction screen 51 on the output device 140, and visualizes the progress status of the work of the picking station 16 performed in the warehouse of the distribution center.

The order information 200 is information on an order requesting shipment of an article and includes information on an article to be picked. The inventory information 220 is related to the inventory of the article, and includes information on the shelf 8 in which the article is accommodated, and information on the arrangement position, quantity, weight, and the like of the article in the shelf 8. A detailed configuration of the inventory information 220 will be described with reference to FIG. 3. The shelf information 230 includes information such as the position and weight of the shelf 8. Here, the order information 200 and the inventory information 220 may be acquired by communication from the distribution center server 500 or the article management server 600. In particular, in an inventory type distribution center, in the distribution center server 500 and the article management server 600, the information on the shelf 8 in which the article is accommodated and the information on the arrangement position, quantity, weight, and the like of the article in the shelf 8 may be held as the master data of inventory management, and these pieces of information can be acquired and used as the inventory information 220. As a result, the characteristics of the weight distribution in each shelf 8 can be considered without the need to introduce new sensors. In addition, since the information can be updated in cooperation with incoming and shipping information, management is easy.

The worker work information 240 includes a work schedule of the worker 17 and information regarding the experience and state of the worker 17. In the worker work information 240, the information regarding the experience and state of the worker 17 may include information such as the height and the presence or absence of injury of the worker 17 and information regarding the continuous work time on the day in addition to the service years of the worker 17. The work schedule information 250 includes information on an article to be worked, a scheduled completion time of the work, a worker who performs the work, and the like for each picking station. Note that the work schedule information 250 is data generated in advance, and may be input from the input device 130 of the warehouse control device 100, or may be received from an external computer (for example, the distribution center server 500), for example.

The device information 260 includes information such as the identification information, position, and operating state of the conveyance device 1. The route data 270 includes information on a route in the warehouse for each conveyance device 1. The work day characteristic information 280 is data in which a work day is attributed according to various conditions. The work day characteristic information 280 may be, for example, attributed according to conditions such as a season, presence or absence of an event, weather, a disaster, and a failure in addition to information such as the total amount of a loading/unloading work, and more specifically, may include information on an event such as a sale held at a mall handled by the distribution center, seasonal information, and information on occurrence of a disaster and a failure.

The station log 310 accumulates the work performed in the picking station 16 and the operation results of the conveyance device 1. The station performance data 320 includes work start time, work end time, work content, and the like among the data for each picking station extracted from the station log 310. The worker performance data 330 extracts data for each worker from the station log 310 and includes work start and end times, work content, work load, and the like.

The performance data by period 340 includes statistical information of the work time for each picking station extracted for each work type from the station performance data 320 for a plurality of preset periods. Note that in the present embodiment, an example in which an average time is employed as the statistical information will be described. The weighting factor 350 includes a numerical value used when the predicted completion time of various works is calculated for each picking station. Note that the weighting factor 350 may be a preset numerical value, but may be a variable value set by the user, or may be a value calculated on the basis of past performance data (for example, by using AI).

The prediction data 290 includes task completion time for each picking station 16 calculated by the data analysis program 163 using the station performance data 320, the worker performance data 330, and the weighting factor 350.

The conveyance device 1 is a moving body that automatically conveys the shelf 8 on which an article is mounted in accordance with a command from the warehouse control device 100, and includes a control device 2, a storage device 4, a drive device 3, a sensor 5, and a communication interface 6. The control device 2 is a microcomputer including an arithmetic device 21 that executes a program and a memory 22 accessible by the arithmetic device 21. The sensor 5 is, for example, a shake sensor, an acceleration sensor, an image sensor, or the like.

The memory 22 stores a self-position estimation program 23, a travel control program 24, a measurement program 25, and a communication program 26. The program executed by the arithmetic device 21 is stored in the memory 22 at least at the time of execution.

The self-position estimation program 23 calculates the position of the conveyance device 1 on the basis of image data (image or moving image data) or the like acquired from the image sensor. Note that the present embodiment shows an example in which a marker indicating a position is provided in advance on a floor surface of a warehouse. The self-position estimation program 23 calculates the position of the conveyance device 1 from the marker read by the image sensor. The marker arranged on the floor surface can be read by the sensor 5 of the conveyance device 1, and for example, a QR code (registered trademark) can be used. Note that the conveyance device 1 may transmit image data or the like acquired from the image sensor to the warehouse control device 100, and the warehouse control device 100 may estimate the position of the conveyance device 1.

The marker is referred to as a mark or a reference marker. For example, the floor of the warehouse is managed as a plurality of sections, and in each of the plurality of sections, the marker representing the section are displayed. The conveyance device 1 travels on the floor, and reads the marker displayed on the floor of each section when passing through the section to acquire information on the section in which the conveyance device 1 is traveling. It is sufficient that the marker includes information for specifying the position of the section, and, for example, the marker may be position information of the section or information (for example, identification information of a section, and the like) that can specify the section.

The travel control program 24 controls the drive device 3 on the basis of the current position of the conveyance device 1 and the route data 270 received from the warehouse control device 100. Note that the warehouse control device 100 transmits the route data 270 for each conveyance device 1 generated by the route creation program 161 to the conveyance device 1, and the conveyance device 1 stores the received data as the route data 41 in the storage device 4.

The measurement program 25 acquires the sensor data acquired by the sensor 5, the control values of the traveling speed and the acceleration acquired from the travel control program 24, and the position of the conveyance device 1 calculated by the self-position estimation program 23, and transmits the data to the warehouse control device 100. The sensor data includes shake data from the shake sensor and image data of the floor surface from the image sensor. In addition, the measurement program 25 may transmit sensor data to the warehouse control device 100 at a predetermined timing (for example, occurrence of a predetermined event) or a predetermined cycle (for example, every 24 hours).

The storage device 4 includes a non-volatile storage medium, and stores a program executed by the control device 2 and data used when the program is executed. For example, the data stored in the storage device 4 includes route data 41, map information 42, measurement data 43, device information 44, travel performance data 45, and floor information 46. The route data 41 is the route data 270 generated by the warehouse control device 100. The map information 42 is the map information received from the warehouse control device 100. The measurement data 43 is the sensor data acquired by the sensor 5 or the data acquired or calculated by each program. The device information 44 includes an identifier (device ID) of the conveyance device 1, the state of the device, information regarding the presence or absence of loading of the shelf 8, the position of the device, a battery remaining amount, a cumulative travel distance, a cumulative number of accelerations, and the like. The device information 44 may be information equivalent to the information regarding the conveyance device 1 in the device information 260. The travel performance data 45 includes a route on which the conveyance device 1 has moved, the state (shake) of the floor surface for each area, a history of a movement mode, and the like.

The drive device 3 includes a carriage 31, a driving wheel 33, a table 32, an auxiliary wheel (caster) 34, a motor 38 as a power source for driving the driving wheel 33 and the table 32, and a battery (not illustrated) for supplying electric power to the motor 38. The motor 38 that drives the driving wheel 33 and the motor 38 that drives the table 32 may be configured as independent motors.

The drive device 3 raises the table 32 at a timing when the conveyance device 1 is positioned below the shelf 8, and loads the shelf 8 on the conveyance device 1. Then, the drive device 3 moves to the instructed position in a state where the conveyance device 1 has loaded the shelf 8, and lowers the table 32 after arriving at the destination to lower the shelf 8 onto the floor surface.

The arithmetic device 21 operates as a functional unit that provides a predetermined function by executing a program of each functional unit. For example, the arithmetic device 21 functions as a travel control unit by executing the travel control program 24. The same applies to other programs. Further, the arithmetic device 21 operates as a functional unit that provides a function of each of a plurality of processes executed by each program.

The station terminal 7 is a terminal device installed for each picking station where the worker 17 works, displays the work schedule information transmitted from the warehouse control device 100 to present work content to the worker 17, and receives an input from the worker 17 to transmit the input to the warehouse control device 100. The station terminal 7 includes a communication interface 71 that controls communication with other devices via the network 90, an input device 72 that includes a touch panel, a keyboard, or the like and to which data is input, an output device 73 that includes a display, a speaker, or the like and outputs data, a control device 74 that includes a microcomputer, a memory, or the like and executes a program, and a storage device 75 that stores, in a nonvolatile storage medium, the program executed by the control device 74 and data used when the program is executed.

The station terminal 7 receives, from the warehouse control device 100, a work schedule to be performed in the picking station 16 in which the station terminal 7 is installed, and stores the work schedule as picking work information 76 in the storage device 75. The station terminal 7 selects a command corresponding to the work situation of the worker 17 from the picking work information 76 and outputs the selected command to the output device 73.

The worker 17 operates the station terminal 7 at the start of a work or after completion of a predetermined work to acquire a work command or the like. The input device 72 of the station terminal 7 includes a picking start button, a picking completion button, a sorting start button, a sorting completion button, a departure button, a stop button, a restoration button, and the like.

For example, the worker 17 operates the picking start button displayed on the display of the station terminal 7 to acquire the designated article from the shelf 8 and carry the article to a predetermined position. When the picking of the designated article is completed, the worker 17 operates the picking completion button displayed on the display of the station terminal 7. Next, the worker 17 operates the sorting start button displayed on the display of the station terminal 7 to sort and pack the picked article. When the designated sorting and packing are completed, the worker 17 operates the sorting completion button displayed on the display of the station terminal 7. For the next work, the worker 17 operates the departure button displayed on the display of the station terminal 7 to move the conveyance device 1 to the warehouse control device 100, and moves the shelf 8 to be picked next to the picking station 16.

When these buttons are operated, the control device 74 transmits the content of the operation received by the input device 72 to the warehouse control device 100. When receiving the content of the operation from the station terminal 7, the warehouse control device 100 accumulates the received content in the station log 310 to be described later.

The warehouse control device 100, the acceptance server 400, the distribution center server 500, and the article management server 600 are computer systems configured on physically one computer or on a plurality of computers configured logically or physically, and may operate on a virtual computer constructed on a plurality of physical computer resources. In addition, each of the computers 100, 400, 500, and 600 may be a device independent in terms of hardware, or may be implemented in terms of software in a device intended for other control.

The programs and data stored in the storage devices 150, 450, 550, and 650 of the warehouse control device 100, the acceptance server 400, the distribution center server 500, and the article management server 600 may be stored in one physical or logical storage device, or may be stored in a plurality of storage devices in a distributed manner.

FIG. 3 is a diagram illustrating a configuration example of the inventory information 220. The inventory information 220 records a record including a record number 221, an article name 222, an article code 223, an inventory quantity 224, a shelf ID 225, an in-shelf arrangement position 226, and an in-shelf arrangement stage number 227 for each position in the shelf for each article.

The shelf ID 225 is identification information of the shelf 8 in which the article is accommodated. The in-shelf arrangement position 226 and the in-shelf arrangement stage number 227 are information to be referred to when a person or a robot picks in the picking station 16 or when determining the moving speed, acceleration, and rotation speed of the conveyance device 1. For example, the in-shelf arrangement position 226 indicates a region (position) in which an article is accommodated among regions divided in an X direction and a Y direction orthogonal to each other with a predetermined corner of the shelf 8 as an origin. In addition, the in-shelf arrangement stage number 227 indicates the number of stages from the bottom in the height direction of a shelf plate 83 in which the article is accommodated. Note that the in-shelf arrangement position 226 is not limited to this example, and information indicating position information of a plurality of compartments included in the shelf 8 may be used instead of the arrangement position 226 and the in-shelf arrangement stage number 227. In addition, when one type of article is accommodated in one compartment of the shelf 8, the in-shelf arrangement position 226 may be unique identification information of the compartment. In addition, the in-shelf arrangement stage number 227 is not limited to this example, and it is sufficient that the in-shelf arrangement stage number 227 may be information indicating the height of the position where the article is accommodated.

Note that the inventory information 220 may record the article weight acquired from the article management server 600.

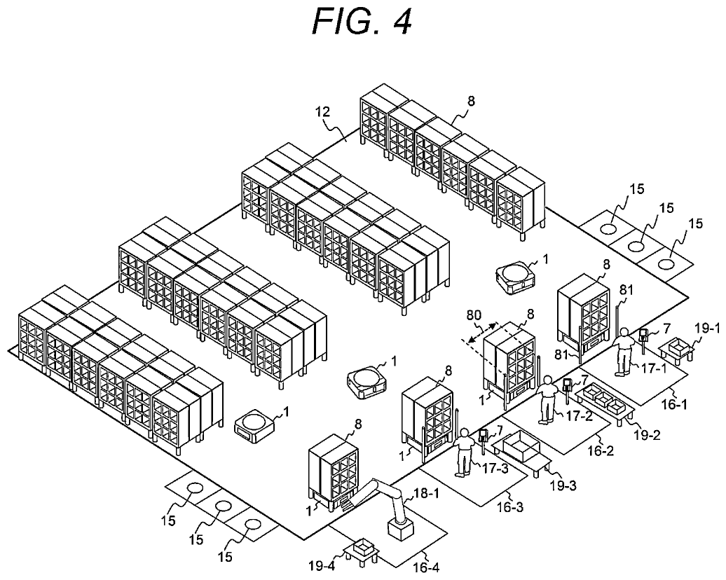

FIG. 4 is a perspective view illustrating an example of a layout of a warehouse in the distribution center. The distribution center has a storage space 12. In the storage space 12, a plurality of shelves 8 are arranged in a lattice pattern in longitudinal and lateral directions. The shelves 8 form “an island” including 2×6 or 1×6 shelves 8.

A plurality of conveyance devices 1 are arranged in the storage space 12. The conveyance device 1 lifts the shelf 8 at a timing when the conveyance device 1 is positioned below the shelf 8, and moves the shelf 8. A plurality of chargers 15 for charging the conveyance device 1 are provided at predetermined places around the storage space 12.

A plurality of picking stations 16-1 to 16-4 are arranged at predetermined positions on the outer edge of the storage space 12. In the picking stations 16-1 to 16-3, workers 17-1 to 17-3 perform the loading task and the unloading task of articles, and in the picking station 16-4, a work robot 18-1 performs the loading task and the unloading task of articles. Note that in the following description, in a case where the picking stations 16 are not individually specified, a reference numeral “16” obtained by omitting “-” and subsequent characters is used. The same applies to the reference numerals of the other components.

The picking station 16 provided at the outer edge portion of the storage space 12 is provided with safety light curtains 81 and 81 for detecting intrusion of the worker 17 into the storage space 12. A work surface 80 on which the shelf 8 is arranged and the picking work is performed is provided between the safety light curtains 81 and 81.

Note that when the shelf 8 is arranged on the work surface 80 by the conveyance device 1, the operation of the safety light curtains 81 and 81 stops, and the worker 17 can perform the picking work. On the other hand, when the picking work is completed and the conveyance device 1 moves the shelf 8 from the work surface 80, the safety light curtains 81 and 81 operate to output an alarm or the like in a case where the worker 17 or the like intrudes from the work surface 80.

In the picking station 16 where the worker 17 performs a work, the station terminal 7 is arranged in the vicinity of the work surface 80. In addition, work spaces 19-1 to 19-4 for sorting and packing are provided at predetermined positions on the periphery of the picking station 16.

The size of the work space 19 and the size of an accommodation portion such as a box for sorting and packing may be different for each picking station 16, and these differences become factors that affect the workability of the worker 17.

In addition, a difference in the positions of the picking stations 16-1 to 16-3 in the warehouse also becomes a factor that affects the operation rate of the worker 17. For example, the environment of the picking station 16 is not all uniform, and there is a tendency that the operation rate of the picking station 16 close to a toilet is high, and the operation rate of the picking station 16 far from the toilet decreases by a walking distance.

In addition, the work time may be affected by a factor of a relative relationship between the position of the picking station 16 and the storage position of the article to be loaded/unloaded. For example, there is a tendency that the operation rate of the picking station 16 close to a position where a relatively large number of articles with relatively high loading/unloading frequency are stored is high. In addition, in another example, there is a tendency that the operation rate of the picking station 16 close to the position where heavy and bulky articles are stored is high, and the work load is relatively large. As described above, the work content, the work load, and the work time vary for each picking station 16. In addition, the variation is not constant, and changes according to the seasons, a change in trends, and a change in a storage position of an article.

In the present embodiment, the work performed by the worker 17 in the picking station 16 is an example of performing the picking work, the sorting work, the departure work, and the standby work for each of the unloading task and the loading task. Note that the standby work refers to a case where the picking station 16 is in a standby state without performing a predetermined work of handling the article, and may be included in the unloading task or the loading task as described above, or may be treated on the same level as the unloading task and the loading task such that a state where the work regarding the unloading task and the loading task is not performed is set as the standby state.

The unloading task is a work of extracting articles accommodated in the shelf 8 according to destinations, classifying the articles for sorting destinations, and accommodating the articles in the accommodation portions for the sorting destinations. The loading task is a work of classifying articles that have arrived at the warehouse into the shelf 8 as an accommodation destination and accommodating the classified articles at predetermined positions on the shelf 8.

Note that in the present embodiment, each work of the unloading task and each work of the loading task are defined as follows.

The picking work of the unloading task is a work in which the worker 17 extracts the designated article from the shelf 8 that has arrived at the work surface 80 and moves the article to the work space 19. Note that the designation of the article can be displayed on the output device 73 of the station terminal 7.

The sorting work of the unloading task is a work of accommodating the article extracted to the work space 19 in a box (transport member) corresponding to the destination and packing the article in the box. Note that the designation of the destination of the article can be displayed on the output device 73 of the station terminal 7.

The departure work of the unloading task is a work in which the picking work of the shelf 8 arranged on the work surface 80 is completed, and the station terminal 7 is operated to request the next shelf 8. The warehouse control device 100 transmits a command to move the shelf 8 of the work surface 80 to the conveyance device 1, and commands another conveyance device 1 to move the next shelf 8 to the work surface 80.

The standby work is a time for waiting for a command regarding the next work such as waiting for assignment of a work to the picking station 16 for both the unloading task and the loading task, and indicates a case where the picking station 16 is in a standby state without performing a predetermined work for handling articles.

The picking work of the loading task is a work of extracting, from a truck or a pallet, a commanded article among the articles having arrived on the work surface 80 and moving the article to the work space 19. Note that the designation of the article is the same as the unloading task, and can be displayed on the output device 73 of the station terminal 7.

The sorting work of the loading task is a work of accommodating the article having moved to the work space 19 in the predetermined shelf 8. Note that the designation of the shelf 8 for accommodating the article can be displayed on the output device 73 of the station terminal 7.

The departure work of the loading task is a work in which the sorting work of the shelf 8 arranged on the work surface 80 is completed, and the station terminal 7 is operated to request the next shelf 8.

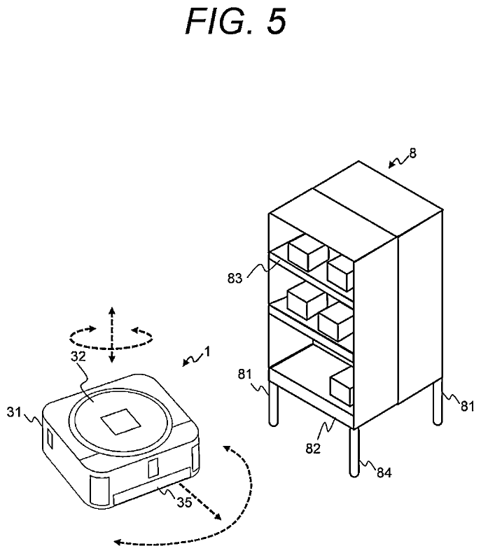

FIG. 5 is a perspective view illustrating a configuration example of the conveyance device 1 and the shelf 8. The conveyance device 1 is an automatic traveling device including a rectangular parallelepiped carriage 31 that is capable of straight movement and rotational movement (also referred to as turning), and the table 32 that is arranged on the upper surface of the carriage 31, is capable of lifting and lowering, and is rotatable. The conveyance device 1 may be, for example, an automated guided vehicle (AGV) or an autonomous mobile robot (AMR). Note that a bumper 35 that mitigates impact at the time of collision may be provided on a side of the carriage 31 in a forward direction. Here, the straight movement refers to movement from a certain point to a different point with directionality. The locus of the straight movement may be a linear locus or a curved locus. Here, the rotational movement refers to a movement in which the conveyance device 1 rotates (turns) to change the traveling direction on the spot. In addition, the rotational movement includes both a case where the conveyance device 1 rotates together with the mounted shelf 8 and a case where the conveyance device 1 is fixed without changing the orientation of the shelf 8. As will be described later, by rotating the table 32 in an opposite direction with respect to the carriage 31, the conveyance device can rotate and move without changing the orientation of the shelf 8. In both the rotational movement in which the orientation of the shelf 8 is changed and the rotational movement in which the orientation of the shelf 8 is not changed, the shelf 8 shakes due to the rotation of the vehicle body or the table 32 of the conveyance device 1. Conditions of speed and acceleration are set for each of the straight movement and the rotational movement.

The shelf 8 for accommodating articles is formed to be a rectangular parallelepiped provided with an opening on each of opposite side surfaces, and is provided with a bottom plate 82 supported by leg portions 84 at a predetermined height from a floor surface, and one or more shelf plates 83 on which the articles are placed.

The conveyance device 1 moves below the bottom plate 82 of the shelf 8 in a state where the table 32 is lowered, and then the conveyance device 1 raises the table 32 to lift the shelf 8 and load the shelf 8. The conveyance device 1 conveys the shelf 8 by moving the carriage 31 in a state where the shelf 8 is loaded on the table 32.

The table 32 is rotatable with respect to the carriage 31, and when the carriage 31 rotates on the floor surface, the table 32 is rotated in the opposite direction with respect to the carriage 31, so that the traveling direction of the carriage 31 may be able to be changed while maintaining the orientation of the shelf 8.

In the illustrated example, the shelf 8 has two opening surfaces, and thus the table 32 is turned by 180° so that a different opening can be provided to the picking station 16. Note that the configuration of the shelf 8 is not limited to the illustrated example, and the shelf 8 may be provided with openings on four surfaces or be a box, a pallet, or the like with a hanger installed as long as the shelf 8 has the bottom plate 82 that the table 32 can lift up.

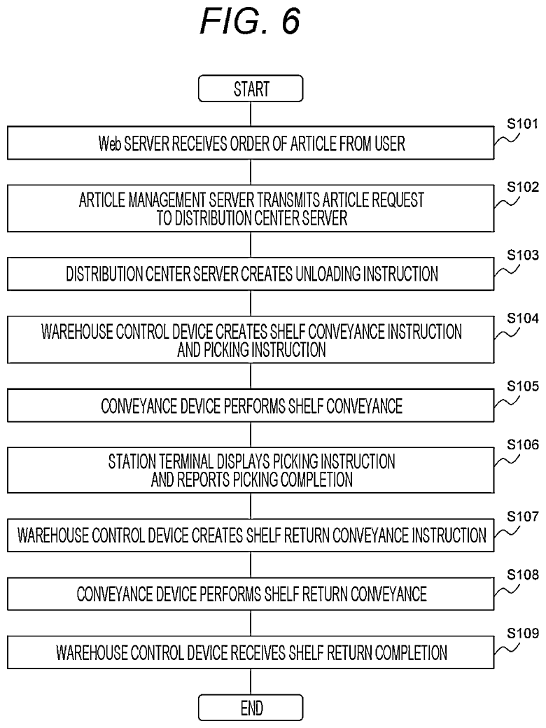

FIG. 6 is a flowchart of an article unloading process executed by the conveyance control system according to the embodiment of the present invention.

First, when the user accesses the acceptance server 400 to request purchase of an article, the acceptance server 400 creates order reception data of the article requested to be purchased by the user, and transmits the created order reception data to the article management server 600 (S101).

Then, the article management server 600 creates an article request on the basis of the order reception data received from the acceptance server 400, and transmits the created article request to the distribution center server 500 (S102).

Then, the distribution center server 500 creates the unloading instruction (unloading work information) on the basis of the received article request, and transmits the created unloading instruction to the warehouse control device 100 (S103).

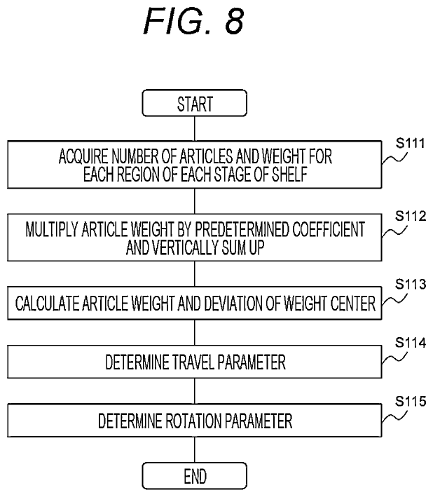

Then, the warehouse control device 100 stores the received unloading instruction in the order information 200, selects the shelf 8 (first movable shelf) accommodating the article instructed to be unloaded on the basis of the unloading instruction, and creates a conveyance instruction (first conveyance instruction) to move the selected shelf 8 to the picking station 16. The conveyance instruction includes information on traveling conditions such as the moving speed, acceleration, and rotation speed of the conveyance device 1, and the warehouse control device 100 acquires storage information including information on articles, the number of the articles, and the storage positions of the articles regarding the first movable shelf, and determines traveling conditions (first traveling conditions) including the moving speed, acceleration, and rotation speed of the conveyance device 1 in consideration of the weight of the shelf 8 and the balance of accommodated objects. The process of determining the moving speed, acceleration, and rotation speed of the conveyance device 1 will be described later with reference to FIG. 8. In addition, the warehouse control device 100 creates a picking instruction for extracting an article instructed to be unloaded from the shelf 8 and shipping the article, and transmits the picking instruction to the station terminal 7 (S104).

Then, the conveyance device 1 conveys the selected shelf 8 according to the conveyance instruction received from the warehouse control device 100 (S105).

Then, the station terminal 7 displays the picking instruction received from the warehouse control device 100 at a timing when the shelf 8 arrives. When the picking work ends, the worker 17 operates the station terminal 7 to perform the departure work. The station terminal 7 reports the completion of the picking work to the warehouse control device 100 (S106).

Then, when the completion of the picking work is received from the station terminal 7, the warehouse control device 100 subtracts the inventory quantity of the unloaded article (unloading work information) from the inventory information 220. Further, the warehouse control device 100 creates a shelf return conveyance instruction, and transmits the created shelf return conveyance instruction to the conveyance device 1 (S107). Similarly to the conveyance instruction, the shelf return conveyance instruction includes the moving speed, acceleration, and rotation speed of the conveyance device 1, and the warehouse control device 100 determines the moving speed, acceleration, and rotation speed of the conveyance device 1 in consideration of the weight of the shelf 8 and the balance of the accommodated objects. The process of determining the moving speed, acceleration, and rotation speed of the conveyance device 1 will be described later with reference to FIG. 8.

Then, the conveyance device 1 performs return conveyance of moving the shelf 8 to the island according to the conveyance instruction received from the warehouse control device 100, and transmits shelf return completion to the warehouse control device 100 (S108).

Then, the warehouse control device 100 receives the shelf return completion from the conveyance device 1 (S109).

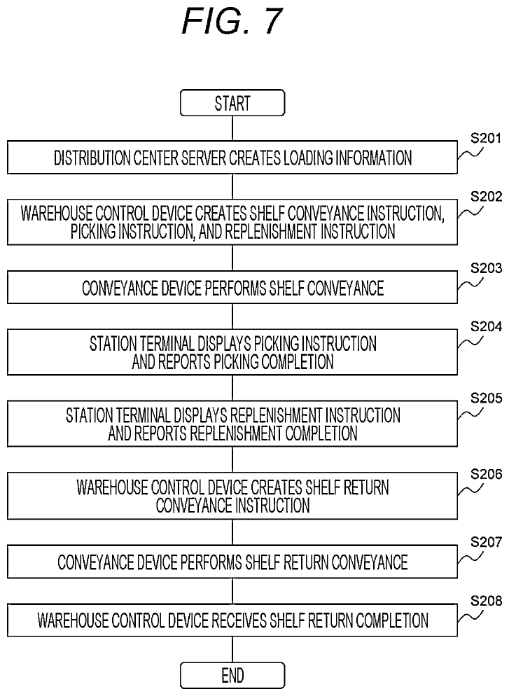

FIG. 7 is a flowchart of an article loading process executed by the conveyance control system according to the embodiment of the present invention.

First, when an article arrives at the warehouse, the distribution center server 500 creates loading information, and transmits the created loading information (loading work information) to the warehouse control device 100 and the article management server 600 (S201). The loading information created by the distribution center server 500 includes at least the identification information and quantity of the article. Note that the weight and size of the article are registered in the article management server 600 at the time of initial loading of the article.

Then, the warehouse control device 100 selects the shelf 8 (second movable shelf) accommodating the loaded article on the basis of the loading information received from the distribution center server 500, and creates a conveyance instruction (second conveyance instruction) to move the selected shelf 8 to the picking station 16. The conveyance instruction includes information on traveling conditions such as the moving speed, acceleration, and rotation speed of the conveyance device 1, and the warehouse control device 100 acquires storage information including information on articles, the number of the articles, and the storage positions of the articles regarding the second movable shelf, and determines traveling conditions (second traveling conditions) including the moving speed, acceleration, and rotation speed of the conveyance device 1 in consideration of the weight of the shelf 8 and the balance of accommodated objects. The process of determining the moving speed, acceleration, and rotation speed of the conveyance device 1 will be described later with reference to FIG. 8. In addition, the warehouse control device 100 creates a picking instruction for extraction from a truck or a pallet and movement to the work space 19, and transmits the picking instruction to the station terminal 7. Further, the warehouse control device 100 creates a replenishment instruction for accommodating the loaded article in the shelf 8, and transmits the replenishment instruction to the station terminal 7 (S202).

Then, the conveyance device 1 conveys the selected shelf 8 according to the conveyance instruction received from the warehouse control device 100 (S203).

Then, the station terminal 7 displays the picking instruction received from the warehouse control device 100. When the picking work ends, the worker 17 operates the station terminal 7 to input the completion of the picking work. The station terminal 7 reports the completion of the picking work to the warehouse control device 100 (S204).

Then, the station terminal 7 displays the replenishment instruction received from the warehouse control device 100 at the timing when the shelf 8 arrives. When the replenishment work ends, the worker 17 operates the station terminal 7 to perform the departure work. The station terminal 7 reports the completion of the replenishment work to the warehouse control device 100 (S205).

Then, when receiving the completion of the replenishment work from the station terminal 7, the warehouse control device 100 adds the inventory quantity of the loaded article to the inventory information 220 on the basis of the loading work information. In addition, in a case where there is no inventory of the article or the article is accommodated in a place different from the current inventory, a record indicating the position of the shelf 8 accommodating the article is added to the inventory information 220. Further, the warehouse control device 100 creates a shelf return conveyance instruction, and transmits the created shelf return conveyance instruction to the conveyance device 1 (S206). Similarly to the conveyance instruction, the shelf return conveyance instruction includes the moving speed, acceleration, and rotation speed of the conveyance device 1, and the warehouse control device 100 determines the moving speed, acceleration, and rotation speed of the conveyance device 1 in consideration of the weight of the shelf 8 and the balance of the accommodated objects. The process of determining the moving speed, acceleration, and rotation speed of the conveyance device 1 will be described later with reference to FIG. 8.

Then, the conveyance device 1 performs return conveyance of moving the shelf 8 to the island according to the conveyance instruction received from the warehouse control device 100, and transmits shelf return completion to the warehouse control device 100 (S207).

Then, the warehouse control device 100 receives the shelf return completion from the conveyance device 1 (S208).

FIG. 8 is a flowchart of a speed/acceleration determination process executed by the conveyance device control program 164 of the warehouse control device 100.

First, the conveyance device control program 164 searches the inventory information 220 with the shelf ID 225, and acquires identification information of the articles accommodated in the shelf 8 to be conveyed, the number of the articles, and the accommodation positions (arrangement position and arrangement stage number). Here, the information regarding the storage of the article in each shelf 8 is also referred to as storage information. Then, using, as a key, the article identification information accommodated in the shelf 8, the weight of the article is acquired from the article management server 600 (S111).

Then, the conveyance device control program 164 multiplies the weight of each article by a predetermined coefficient for each stage and vertically sums the result for each region of the shelf 8 (S112). For example, as illustrated in FIG. 3, by using the in-shelf arrangement stage number 227 of the inventory information 220, the predetermined coefficient may be set to be larger toward the upper stage such that the predetermined coefficient is 1 for the first stage from the bottom (lower stage), the predetermined coefficient is 2 for the second stage from the bottom (middle stage), and the predetermined coefficient is 3 for the third stage from the bottom (upper stage). By setting the coefficient to be larger toward the upper stage, it is detected whether the center of gravity of the shelf 8 is above or below, and the speed and acceleration at the time of conveyance of the shelf 8 where the center of gravity is above and shake is likely to occur are set low.

Then, the conveyance device control program 164 calculates an article weight and a deviation of an article weight center of the shelf 8 (S113). For example, the article weight can be calculated by summing the value obtained by multiplying the number of articles accommodated in the shelf 8 by the weight. In addition, for the deviation of the article weight center, assuming that the weight of the article vertically summed in step S112 is at the center of each region in the lower stage, the weight of the article in each region is multiplied by the X coordinate of each region and is summed to calculate the center-of-gravity position in the X direction. Similarly, a value obtained by multiplying the weight of the article in each region by the Y coordinate of each region is summed to calculate the center-of-gravity position in the Y direction. Then, a distance dx in the X direction and a distance dy in the Y direction between the calculated center-of-gravity position and a center-of-gravity position in an empty load state are calculated. Note that the traveling direction of the conveyance device 1 is positive in the X direction, and the direction (the right side in the traveling direction) orthogonal to the traveling direction of the conveyance device 1 is positive in the Y direction.

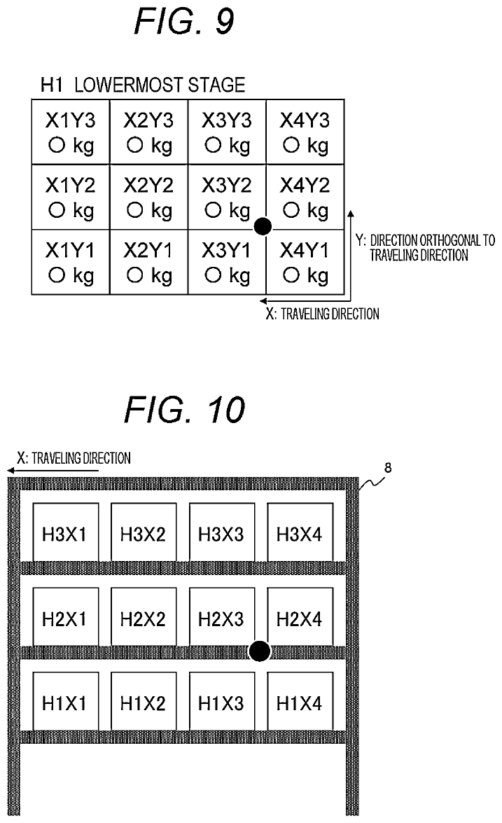

In the present embodiment, characteristics regarding the weight distribution of various articles can be adopted. For example, as illustrated in FIG. 9, in the article weight center, the position of the weight center indicated by a black circle in the drawing is calculated by summing the value obtained by multiplying the weight of the article on each stage by the coefficient and converting the sum into the weight at the lowermost stage. In addition, as illustrated in FIG. 10, the position of the article weight center in the height direction may be calculated three-dimensionally. In addition, a three-dimensional map obtained by three-dimensionally mapping a relationship between the accommodation portion (for example, a tray, a container, a box, and the like accommodated in the compartment) of the shelf 8 and the article weight may be used. Then, in steps S114 and S115, a traveling condition including at least one of a speed and an acceleration during each of the straight movement and the rotational movement and a steering angle during the straight movement is determined according to the position of the article weight center in the height direction, and traveling control is performed according to the determined traveling condition. Here, the steering angle is an angle by which the direction of travel is corrected when the conveyance device moves straight, and it is necessary to correct the direction of travel. In other words, the steering angle is an angle formed by the traveling direction before correction and the traveling direction after correction. In addition, here, an example of calculating the article weight and the article weight center of the shelf 8 has been described. However, a configuration may be made such that the center-of-gravity position of the shelf 8 including the weight of the shelf 8 itself is calculated, and the traveling condition of the conveyance device is determined the basis of the on characteristics of the weight distribution including the weight of the shelf 8 itself. Further, a configuration may be made such that the center-of-gravity position including the weight of the shelf 8 and the weight of the conveyance device 1 are calculated, and the traveling condition of the conveyance device may be determined on the basis of the characteristics of the weight distribution including the weights of the shelf 8 and the conveyance device 1.

An example in which the traveling direction needs to be determined by the steering angle will be described. In a case where the position of the weight center of the shelf 8 to be conveyed by the conveyance device 1 is separated by a predetermined distance or more with respect to the direction (hereinafter, referred to as a left-right direction) orthogonal to the traveling direction of the straight movement, the actual locus of the conveyance device 1 at the time of performing the straight movement may be deviated in the left-right direction. In a case where such a deviation in the left-right direction can be predicted in advance, or in a case where the deviation is detected by self-position estimation of 1 of the conveyance device, it is possible to correct the traveling direction of the conveyance device 1 by a predetermined steering angle. The correction of the traveling direction by the steering angle is not limited to the case described above, and can be performed in a case where it is detected that the traveling direction of the straight movement of the conveyance device 1 deviates in the left-right direction due to various factors such as the road surface condition of the traveling path. At this time, an upper limit value may be set for the steering angle applied to the conveyance device 1.

Next, a relationship between the correction of the traveling direction by the set steering angle and the weight characteristics of the shelf 8 will be described in detail. It is assumed that the position of the weight center of the shelf 8 to be conveyed by the conveyance device 1 is separated from a reference position by a predetermined distance or more in the left-right direction. At this time, the traveling speed of the conveyance device 1 is larger than a predetermined value, and the shelf 8 may swing greatly left and right at the time of direction change. Therefore, the upper limit value of the steering angle may be controlled to be small. When the upper limit value of the steering angle is reduced, the upper limit value of the steering angle may be lower than the deviation amount in the left-right direction, but in this case, steering may be controlled to be executed a plurality of times within a range satisfying the condition of the upper limit value of the steering angle such that the traveling direction is corrected by the deviation amount in the left-right direction. As a result, it is possible to reduce the shake occurring on the shelf 8 at the time of direction change without greatly affecting the traveling speed of the conveyance device 1.

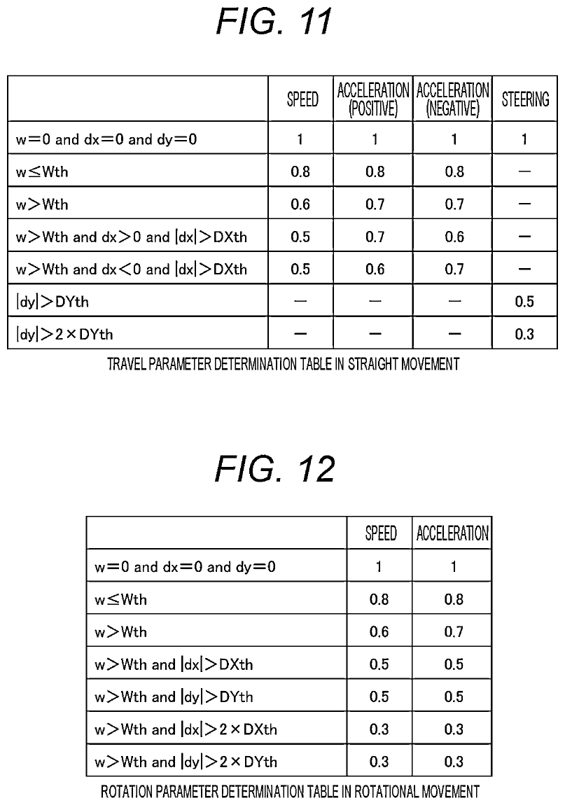

Then, the conveyance device control program 164 refers to the travel parameter determination table (FIG. 11) in the straight movement, and determines the travel parameter of the conveyance device 1 on the basis of a calculated article weight w, the deviation dx of the center-of-gravity position in the traveling direction, and the deviation dy of the center-of-gravity position in the left-right direction (S114). As illustrated in FIG. 11, in the travel parameter determination table, coefficients of the speed, the acceleration, and the steering are determined for each condition of the article weight and the deviation of the center-of-gravity position in the traveling direction, and the upper limit values of the speed, the acceleration, and the steering are determined according to the coefficients.

For example, in a case where the article weight w is equal to or less than a predetermined threshold value Wth, the maximum speed and the maximum acceleration are set to 80% of those in the case of an empty load (w=0), and the shaking of the shelf 8 is reduced. In addition, in a case where the article weight w is larger than the predetermined threshold t value Wth, the maximum speed is set to 60% of that in the case of an empty load (w=0), and the maximum acceleration is set to 70% of that in the case of an empty load (w=0), and the shaking of the shelf 8 is reduced. In addition, in a case where the article weight w is larger than the predetermined threshold value Wth, the deviation dx of the article weight center in the traveling direction is positive, and in a case where a deviation amount |dx| of the article weight center in the traveling direction is larger than a predetermined threshold value DXth, the article weight center is on the front side by a predetermined amount or more, and thus, it is necessary to reduce shaking of the shelf 8 at the time of decelerating. For this reason, the maximum speed is set to 60% of that in the case of an empty load (w=0), the positive maximum acceleration is set to 70% of that in the case of an empty load (w=0), and the negative maximum acceleration (deceleration) is set to 60% of that in the case of an empty load (w=0), thereby reducing the shaking of the shelf 8 at the time of decelerating. Further, in a case where the article weight w is larger than the predetermined threshold value Wth, the deviation dx of the article weight center in the traveling direction is negative, and the deviation amount |dx| of the article weight center in the traveling direction is larger than the predetermined threshold value DXth, the article weight center is on the rear side by a predetermined amount or more, and thus it is necessary to reduce the shaking of the shelf 8 at the time of accelerating. For this reason, the maximum speed is set to 60% of that in the case of an empty load (w=0), the positive maximum acceleration is set to 60% of that in the case of an empty load (w=0), and the negative maximum acceleration (deceleration) is set to 70% of that in the case of an empty load (w=0), thereby reducing the shaking of the shelf 8 at the time of accelerating.

Here, in the above-described example, the article weight w is calculated by summing the value obtained by multiplying the weight of the article in each stage by a coefficient corresponding to the height of the storage position. The coefficient corresponding to the storage position is set such that the coefficient becomes larger toward the upper stage. As a result, in a case where the center of gravity of the shelf 8 is above, the article weight w is output as a larger value. Therefore, there is a high possibility that the article weight w exceeds the threshold value Wth, and as a result, the speed and acceleration at the time of conveyance of the shelf 8 in which the center of gravity is located above and shaking is likely to occur are set low. In addition, in the example of FIG. 11, for the sake of simplicity, an example in which the threshold value Wth is one is illustrated, but a plurality of threshold values may be provided, and a travel parameter corresponding to each threshold value may be set.

An example of the calculation method in which the center-of-gravity position of the shelf 8 or the height of the weight center of the article stored in the shelf 8 is taken into consideration is not limited to the above-described method. As illustrated in FIG. 10, the position of the article weight center in the height direction may be calculated three-dimensionally. Then, a threshold value corresponding to the height of the article weight center may be set, and the traveling condition of the conveyance device 1 may be determined on the basis of a comparison between the center-of-gravity position of the shelf 8 or the height of the weight center of the article stored in the shelf 8 and the threshold value.

Next, a method of determining the upper limit value of the steering angle will be described on the basis of the example of FIG. 11. For example, when referring to the parameters regarding steering in the rightmost column of FIG. 11, in a case where a lateral deviation amount |dy| of the article weight center is larger than a predetermined threshold value DYth, the upper limit value of the steering angle may be set to 50% of that in the case of an empty load (w=0). In addition, when the lateral deviation amount |dy| of the article weight center is larger than twice the predetermined threshold value DYth, the upper limit value of the steering angle may be set to 30% of that in the case of an empty load (w=0). Accordingly, the shaking of the shelf 8 in the lateral direction at the time of turning is reduced. Further, as described above, when the upper limit value of the steering angle is smaller than the deviation amount in the left-right direction, steering may be executed a plurality of times within a range satisfying the condition of the upper limit value of the steering angle such that the traveling direction is corrected by the deviation amount in the left-right direction. Therefore, the conveyance device control program 164 may determine the number of times and a timing of the process of correcting the traveling direction, on the basis of the determined upper limit value of the steering angle. In addition, here, an example has been described in which the upper limit value of the steering angle is changed in a case where the position of the weight center of the shelf 8 to be conveyed by the conveyance device 1 is separated from the reference position by a predetermined distance or more in the left-right direction, but the present invention is not limited to this example. Instead of or in addition to changing the upper limit value of the steering angle, the traveling speed in the straight movement may be controlled to be set lower. In this case, calculation may be performed in consideration of both the coefficients derived in the evaluation of the deviation amount dx in the traveling direction described above, or a smaller coefficient may be used. As a result, it is possible to reduce shaking that occurs on the shelf 8 at the time of direction change.

Here, in the example illustrated in FIG. 11, an example in which the rotation parameter can be determined regardless of the article weight w in the evaluation of the lateral deviation dy of the center-of-gravity position has been described, but the article weight w may be further included in the evaluation.

Then, the conveyance device control program 164 determines the travel parameters including the traveling speed of the conveyance device 1, the acceleration at the time of accelerating, the acceleration (deceleration) at the time of decelerating, and the steering angle, so as not to exceed the determined maximum speed and maximum acceleration.

The conveyance device control program 164 refers to the rotation parameter determination table (FIG. 12) in the rotational movement, and determines the rotation parameter of the conveyance device 1 on the basis of the calculated article weight w, the deviation dx of the center-of-gravity position in the traveling direction, and the deviation dy of the center-of-gravity position in the left-right direction (S115). In a case where the article weight center is positioned away from the weight center in an empty load state by a predetermined distance or more, it is possible to reduce the shaking of the shelf 8 during the rotational movement by limiting the speed and the acceleration when the conveyance device 1 changes the traveling direction and performs the rotational movement together with the shelf 8. Here, the traveling direction indicates a direction in which the front of the conveyance device 1 is directed.

Here, description of portions overlapping with the description of FIG. 11 will be omitted, and a case where the article weight w is larger than the predetermined threshold value Wth will be described. For example, in a case where the lateral deviation amount |dy| of the article weight center in the lateral direction is larger than a predetermined threshold value DYth, or a case where the deviation amount |dx| of the article weight center in the traveling direction is larger than the predetermined threshold value DXth, the upper limit value of the speed or the acceleration at the time of rotational movement is set to 50% of that in the case of an empty load (w=0) to reduce the shaking of the shelf 8 in the lateral direction at the time of turning. In addition, in a case where the deviation amount |dx| of the article weight center in the traveling direction is larger than twice the predetermined threshold value DXth, or a case where the deviation amount |dy| of the article weight center in the lateral direction is larger than twice the predetermined threshold value DYth, the upper limit value of the speed or the acceleration at the time of rotational movement is set to 30% of that in the case of an empty load (w=0) to reduce the shaking of the shelf 8 in the lateral direction at the time of turning.

Then, the conveyance device control program 164 determines the rotation parameter of the conveyance device 1 so as not to exceed the determined upper limit value of the acceleration.

Note that it is sufficient that the conveyance device control program 164 determines the travel parameter and the rotation parameter according to the control content of the conveyance device 1. For example, in a case where the conveyance device 1 arrives at the destination only by straight movement without rotating the shelf 8, the travel parameter may be determined without determining the rotation parameter. In addition, in a case where the conveyance device 1 rotates the shelf 8 without moving straight, the rotation parameter may be determined without determining the travel parameter.

In the travel parameter determination process of step S114 and the rotation parameter determination process of step S115, the upper limit value of the travel parameter is limited with reference to the travel parameter determination table, but the travel parameter may be determined using a function in which the article weight and the deviation of the center-of-gravity position are used as explanatory variables and the travel parameters (speed, acceleration, steering) are used as objective variables.

As described above, according to the conveyance control system of the present embodiment, the optimum traveling conditions (speed, acceleration, steering angle) in a range in which the shaking of the shelf 8 and the conveyance device 1 can be reduced can be set according to the weight distribution characteristics of the articles accommodated in the shelf 8 loaded on the conveyance device 1, thereby improving the conveyance efficiency of the conveyance device. In addition, according to the conveyance control system of the present embodiment, the traveling conditions are determined on the basis of the storage information of the article managed in the control system, and thus it is not necessary to newly introduce sensors. Therefore, this contributes to improvement of user convenience, and further contributes to energy saving and environmental load reduction.

Note that the present invention is not limited to the above-described embodiments, and includes various modifications and equivalent configurations within the spirit of the appended claims. For example, the above-described embodiments have been described in detail for easy understanding of the present invention, and the present invention is not necessarily limited to those having all the described configurations. In addition, some of the configurations of one embodiment may be replaced with the configurations of another embodiment. In addition, the configuration of one embodiment may be added with the configuration of another embodiment. In addition, addition, deletion, and replacement of other configurations may be performed on some of the configurations of each embodiment.

In addition, some or all of the above-described configurations, functions, processing units, processing means, and the like may be realized with hardware by, for example, designing with an integrated circuit, or may be realized with software by a processor interpreting and executing a program for realizing each function.

Information such as a program, a table, and a file for realizing each function can be stored in a storage device such as a memory, a hard disk, or a solid state drive (SSD), or a recording medium such as an IC card, an SD card, or a DVD.

In addition, control lines and information lines are illustrated in consideration of necessity for the description, and not all control lines and information lines necessary for implementation are illustrated. In practice, it may be considered that almost all configurations are connected to each other.

1. A control system comprising:
a storage device that stores storage information including information regarding an article stored in a movable shelf for storing articles and a storage position of the article; and
an arithmetic controls traveling of a conveyance device that loads and conveys the movable shelf, wherein
the arithmetic device
calculates a characteristic regarding a weight distribution of the movable shelf on a basis of the storage information, and
determines a traveling condition including information on at least one of speed and acceleration of the conveyance device on a basis of the characteristic regarding the weight distribution.

2. The control system according to claim 1, wherein
the conveyance device is capable of straight movement, and
the arithmetic device determines acceleration at time of accelerating and acceleration at time of decelerating in a straight movement direction, on a basis of a deviation amount of a weight center of the article accommodated in the movable shelf from a weight center in an empty load state in a traveling direction of the straight movement.

3. The control system according to claim 2, wherein
in a case where the weight center of the article accommodated in the movable shelf is positioned ahead of the weight center in the empty load state by a predetermined distance or more in the traveling direction, the arithmetic device determines the acceleration such that an upper limit value of an absolute value of the acceleration at time of decelerating is smaller than that in the empty load state.

4. The control system according to claim 2, wherein
in a case where the weight center of the article accommodated in the movable shelf is positioned behind the weight center in the unloaded state by a predetermined distance or more in the traveling direction, the arithmetic device determines the acceleration such that an upper limit value of the acceleration at time of accelerating is smaller than that in the empty load state.

5. The control system according to claim 1, wherein
the conveyance device is capable of rotational movement to rotate an orientation of the conveyance device, and
in a case where the weight center of the movable shelf is positioned away from the weight center in an empty load state by a predetermined distance or more, the arithmetic device determines the acceleration such that an upper limit value of the acceleration in the rotational movement is smaller than that in an empty load state.

6. The control system according to claim 1, wherein
the conveyance device is capable of straight movement,
the storage device stores information regarding an upper limit value of a steering angle which is an angle formed by a traveling direction before correction and a traveling direction after correction in a case where the conveyance device corrects the traveling direction in the straight movement, and
in a case where the weight center of the article accommodated in the movable shelf is positioned away from the weight center in an empty load state by a predetermined distance or more in a direction orthogonal to the traveling direction, the arithmetic device determines the upper limit value of the steering angle to be smaller than that in the empty load state.

7. The control system according to claim 6, wherein
the arithmetic device determines the number of times and a timing of a process of correcting the traveling direction on a basis of the determined upper limit value of the steering angle.

8. The control system according to claim 1, wherein
the arithmetic device determines the traveling condition including information on at least one of the speed and the acceleration on a basis of a height of a weight center of the movable shelf.

9. The control system according to claim 1, wherein
the arithmetic device determines the traveling condition including information on at least one of the speed and the acceleration on a basis of a total weight of the articles accommodated in the movable shelf and a characteristic regarding the weight distribution.

10. The control system according to claim 9, wherein
the arithmetic device determines an upper limit value of the speed on a basis of a weight of the article accommodated in the movable shelf.

11. The control system according to claim 9, wherein
the arithmetic device
determines an upper limit value of the speed of the conveyance device to be a first speed in a case where a weight of the article accommodated in the movable shelf is equal to or less than a predetermined reference, and
determines the upper limit value of the speed of the conveyance device to be a second speed smaller than the first speed in a case where the weight of the article accommodated in the movable shelf is larger than the predetermined reference.

12. The control system according to claim 1, wherein
the movable shelf has a plurality of compartments, and each of the compartments is capable of accommodating an accommodation portion, and
the storage information is information on a position of the accommodation portion and an article accommodated in the accommodation portion.

13. The control system according to claim 1, wherein
the movable shelf includes a plurality of compartments,
the storage information includes information on the number of articles accommodated in each of the plurality of compartments, and
the arithmetic device
acquires the storage information regarding a first movable shelf selected on a basis of unloading work information at time of unloading the article from the movable shelf,
the storage information regarding the first movable shelf including information on the number of articles accommodated in each of a plurality of compartments of the first movable shelf,
determines a first traveling condition which is a traveling condition of the conveyance device on a basis of the storage information regarding the first movable shelf,
transmits a travel instruction including the determined first traveling condition to the conveyance device,
updates the storage information regarding the first movable shelf on a basis of the unloading work information in a case where a work of unloading an article from the first movable shelf conveyed by the conveyance device is completed,
acquires the storage information regarding a second movable shelf selected on a basis of loading work information at time of loading an article into the movable shelf,
the storage information regarding the second movable shelf including information on the number of articles accommodated in each of a plurality of compartments of the second movable shelf,
determines a second traveling condition which is a traveling condition of the conveyance device on a basis of the storage information regarding the second movable shelf,
transmits a travel instruction including the determined second traveling condition to the conveyance device, and
updates the storage information regarding the first movable shelf on a basis of the loading work information in a case where a work of loading an article to the second movable shelf conveyed by the conveyance device is completed.

14. A conveyance system comprising:
a movable shelf that stores an article and is installed to be movable;
a conveyance device that conveys the movable shelf; and
a control device that controls traveling of the conveyance device, wherein
the control device includes
a storage unit that stores storage information including information regarding an article stored in the movable shelf and a storage position of the article, and an arithmetic unit that executes a predetermined arithmetic process, and
the arithmetic unit
calculates a characteristic regarding a weight distribution of the movable shelf on a basis of the storage information, and
transmits, to the conveyance device, a conveyance instruction of the movable shelf including a traveling condition including information on at least one of speed and acceleration of the conveyance device, on a basis of the characteristic regarding the weight distribution.

15. A control method in which a control device controls movement of a conveyance device that conveys a movable shelf that accommodates an article, wherein
the control device includes a storage unit that stores storage information including information regarding an article accommodated in the movable shelf and a storage position of the article, and an arithmetic unit that executes a predetermined arithmetic process, and
the control method includes
a step of calculating a characteristic regarding a weight distribution of the movable shelf on a basis of the storage information, and
determining a traveling condition including information on at least one of speed and acceleration of the conveyance device on a basis of the characteristic regarding the weight distribution.
